(19) United States
(12) Patent Application Publication
(10) Pub. No.: US 2022/0094033 A1
(43) Pub. Date: Mar. 24, 2022

(54) A COATED GLAZING WITH IMPROVED READABILITY AND A METHOD THEREOF

(71) Applicant: SAINT-GOBAIN GLASS FRANCE, COURBEVOIE (FR)

(72) Inventors: Arunvel THANGAMANI, Tamil Nadu (IN); Samson RICHARDSON D, Tamil Nadu (IN)

(21) Appl. No.: 17/433,665

(22) PCT Filed: Feb. 26, 2020
(86) PCT No.: PCT/IN2020/050174

§ 371 Date: Aug. 25, 2021

(30) Foreign Application Priority Data
Feb. 26, 2019 (IN) 201941007427

(51) Int. Cl. H01Q 1/12; H01Q 1/22; H01Q 1/40; G06K 19/077

(52) U.S. Cl. CPC H01Q 1/1271; H01Q 1/2225; G06K 19/07722; G06K 19/07773; G06K 19/07745; H01Q 1/40

(57) ABSTRACT

A coated laminated glazing providing improved readability for data transponder device is disclosed. The coated laminated glazing includes a surface coating layer provided on at least one of face two or face three of the laminated glazing and having an etched area selectively provided on the surface coating layer. The coated laminated glazing includes a data transponder or antenna positioned below the etched area and sandwiched between a first substrate and a second substrate of the laminated glazing. Alternatively, the coated laminated glazing is fixed in close proximity to the etched area to face 1 or face 4 of the laminated glazing. The etched area is characterized by a plurality of disjoint patterns to provide improved data readability through RF transparency. The coated laminated glazing further includes one or more interlayers disposed between the first substrate and the second substrate.

### TECHNICAL FIELD

The present disclosure relates generally to a coated laminated glazing of a vehicle embedded with one or more data transponders and more particularly to a laminated glazing with better readability performance of the data transponders.

### BACKGROUND

Background description includes information that may be useful in understanding the present disclosure. It is not an admission that any of the information provided herein is prior art or relevant to the presently claimed invention, or that any publication specifically or implicitly referenced is prior art.

Currently RFID and NFC tags are provided on the vehicle windshields in the form of stickers and used as a data storage device to store vehicle related data or information. Also, there exists solutions that disclose embedding of a data transponder between the laminated glazing or the windshield.

U.S. Pat. No. 6,275,157 to Mays et al. discloses a data transponder comprising a glass panel and RFID device, which is at least partially embedded in the glass panel. Another Indian patent application from the current applicant, 201741020258 discloses a laminated glazing with an RFID/NFC device disposed between a first substrate and the second substrate of the laminated glazing. However, when the first substrate or the second substrate is coated with a metallic layer or metal oxide layer, the readability of the RFID device is affected. The metallic layer or metal oxide layer causes backscattering and range variation when the data transponder is positioned adjacent thereto. In a scenario where face three of the laminated glazing is coated, and the RFID device is embedded thereon, grounding effect occurs on face three disruption conduction. Hence we need a solution to address the abovementioned problems associated with data transponder performance in a coated laminated glazing.

When RFID is affixed onto face one and face four of a coated laminated glazing, the readability and performance of the RFID device is also affected by reflection of RF waves from the metallic coating. Removing a specific portion of coating from the laminated glazing at an area adjoining/aligned with the RFID device, addresses the problem of RF wave reflection and RFID device readability. The removal of the coating results in the RFID device being exposed to sun, UV and prone to damage. Thus, there exists need for a method that improves performance of data transponder device in the laminated glazing while ensuring protection to the data transponder device.

U.S. Pat. No. 9,758,021 mentions a method of creating a window in the coating surface by removing the entire portion of the coated surface. This results in losing the functionality of the portion which is removed such as UV protection, defrosting properties etc. This functionality is completely lost in the local cutout portion. Thus we need a solution that will retain the functionality of the coating and not compromise on the performance of the tag.

Methods have been developed to address the problem of readability of data transponders attached to the glazing. There exist patents that disclose a method of manufacturing a glazing having a frequency selective surface using laser beam. European patent EP2640549 discloses a method of depositing a coating on a substrate to provide RF transparency. Subsequently, a laser beam is provided on the coating by laser ablation to form lines having a spacing selected to provide transparency of the coating to RF radiation of a desired wavelength. EP2640549 patent focusses on providing random slits in a coating layer and thereby achieving the performance for data transponders. These random slits can enhance the reading performance. However, the exposed slits can possibly lead to tag degradation and failure of the RFID device in case of harsher process parameters. Further, the random slits cause metallic reflection of RF waves, thereby affecting readability. The existing solutions do not explain a method of qualifying the tag performance.

In view of the above discussion, there exists the need for a coated glazing that provides improved readability for a RFID device or an antenna. Further, it would be desirable to provide a windshield with data transponder devices having enhanced protection, durability and data readability performance. Furthermore, there exists the need for selectively remove the coating of the coated laminated glazing to eliminate problems associated with electromagnetic interference, metallic reflection of RF waves and grounding of the RFID device.

### SUMMARY OF THE DISCLOSURE

Other features and aspects of this disclosure will be apparent from the following description and the accompanying drawings. In order to overcome the disadvantages mentioned in the background, the present disclosure provides a coated laminated glazing with improved readability for a RFID device or antenna embedded therein, while ensuring protection for the RFID device. The readability is improved by selectively providing disjoint etching patterns on the coated substrate of the glazing that creates RF transparency. Another object of the present invention is to provide a windshield with data transponder that provides optimum performance with durability by the selective etching patterns masking the data transponder. The present invention aims to address the problems of electromagnetic interference due to electrical conductivity through coating, reflection of RF waves due to metal layer in glazing and eliminate grounding caused due to the embedding of RFID device on the laminated glazing.

The present disclosure provides a coated laminated glazing having a first substrate, a second substrate and one or more interlayers that is designed to provide improved readability. The glazing comprises a surface coating layer provided on at least one substrate and one or more etched area selectively provided on the surface coating layer. Further, the glazing comprises a data transponder or an antenna sandwiched between the first substrate and the second substrate proximal to the etched area or attached externally to the first substrate and the second substrate proximal to the etched area. The etched area is characterized by a plurality of disjoint patterns to provide improved readability of the data transponder or the antenna. The one or more disjoint patterns are provided to disable electrical conductivity and infinite conduction of the wirelessly received RF power in the coating region.

In an embodiment, the surface coating layer is present on an outer layer of the first substrate, an inner layer of the first substrate, an outer layer of the second substrate, and an inner layer of the second substrate. The one or more disjointed etched patterns minimizes electromagnetic reflection. The coated glazing comprises a protective layer selectively disposed between the first substrate and the second substrate to provide mechanical integrity, ultra-violet protection, thermal resistance and electrical insulation for the data transponder. The etching is selectively performed to enable RF transparency in the antenna area of the data transponder while surface coating layer is retained in the chip area of the data transponder for enabling UV protection.

According to an embodiment of the present invention, a method of manufacturing a coated laminated glazing used in vehicles with data transponders embedded. The method includes depositing a coating uniformly on a substrate of the laminated glazing, the coating being non-transmitting to radio frequency (RF) radiation. The coating is formed of a surface coating layer of metal or metal oxides. The coated is provided on inner layer of the first substrate or outer layer of the second substrate. Thereafter, an area of the coated substrate is selectively etched to remove a portion of the coating to form one or more disjoint patterns on the substrate that disable electrical conductivity in the selected area. The disjoint patterns can be uniform or non-uniform in the etched area. The disjoint pattern is dense in a first area and minimal in a second area. Subsequently, the coated substrate is bend so that the coated second face forms into a concave shape. A protective layer is deposited to mask the etched area. Thereafter, the data transponder is positioned vertically aligned to the etched area on the substrate. A second substrate is positioned beneath the substrate having the data transponder sandwiched between the first substrate and the second substrate. A vacuum de-airing of the sandwiched first substrate and the second substrate is performed. Finally, the autoclaving of the sandwiched first substrate and the second substrate is performed.

### BRIEF DESCRIPTION OF THE DRAWINGS

Embodiments are illustrated by way of example and are not limited in the accompanying figures.

FIG. 1A illustrates an exploded view of the coated laminated glazing of the current disclosure, according to an embodiment of the present disclosure;

FIG. 1B illustrates an exploded view of the coated laminated glazing of the current disclosure, according to another embodiment of the present disclosure;

FIG. 1C illustrates a cross sectional view of the coated laminated glazing with protective layer, according to an embodiment of the present disclosure

FIGS. 2A and 2B illustrates a perspective view of a windshield with etching pattern, according to an exemplary embodiment of the present invention;

FIG. 2C illustrates a coated laminated glazing for a windshield with one or more disjoint patterns;

FIGS. 3A, 3B and 3C illustrates various examples of the etching pattern;

FIG. 4A illustrates an experimental setup to measure performance of the RFID device embedded in the coated laminated glazing;

FIG. 4B illustrates the readability data obtained with various etching patterns; and

FIG. 5 illustrates a flowchart for a method of manufacturing a coated laminated glazing used in vehicles with data transponders embedded.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The present invention is now discussed in more detail referring to the drawings that accompany the present application. In the accompanying drawings, like and/or corresponding elements are referred to by like reference numbers.

Wherever possible, the same reference numbers will be used throughout the drawings to refer to the same or the like parts. The present disclosure is to provide an improved automobile glazing incorporating other functions in addition to the usual one. The present disclosure further provides an improved automobile glazing embedded with one or more data transponders and more particularly to a laminated glazing with better readability performance of the data transponders.

The present disclosure provides a coated laminated glazing having a first substrate, a second substrate and one or more interlayers that is designed to provide improved readability. The glazing comprises a data transponder provided on at least one substrate and one or more etched area selectively provided on the surface coating layer. Further, the glazing comprises a data transponder or an antenna sandwiched between the first substrate and the second substrate proximal to the etched area or attached externally to the first substrate and the second substrate proximal to the etched area.

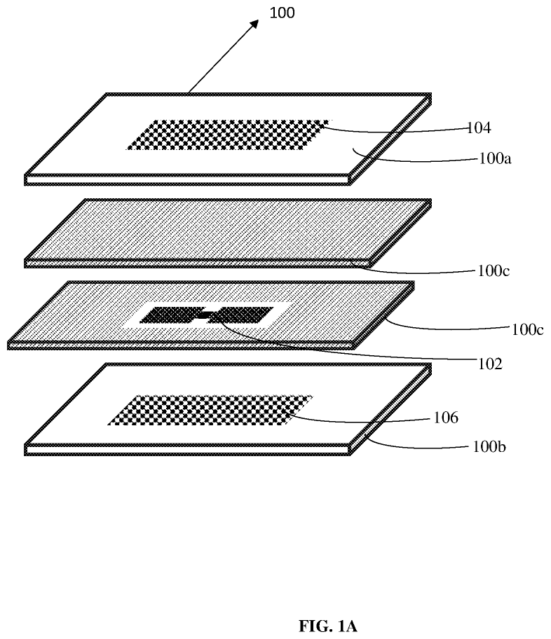

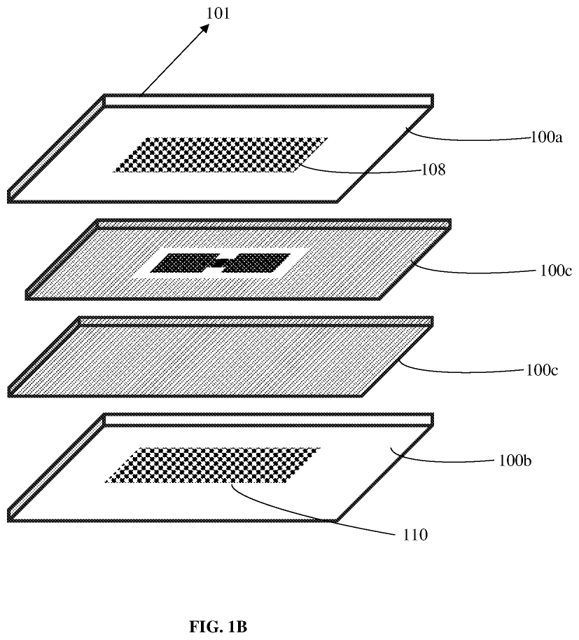

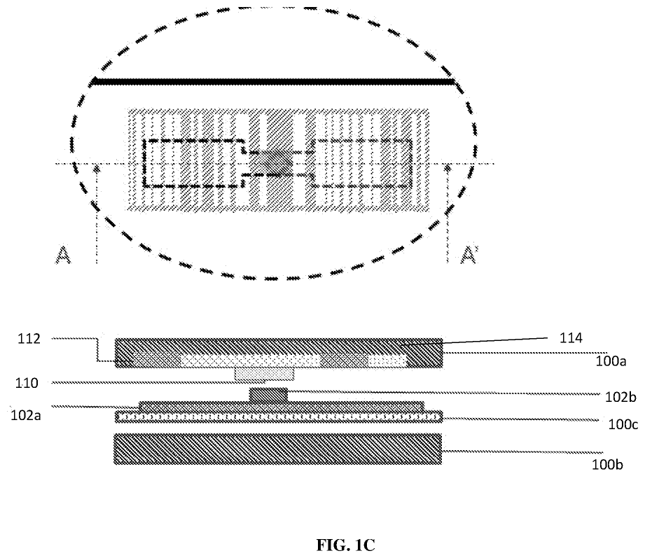

FIG. 1A illustrates an exploded view of the coated laminated glazing 100 of the current disclosure embedded with a data transponder device 102. In an embodiment, the data transponder device 102 is a RFID device, near field communication (NFC) device or an antenna. In an embodiment, the coated laminated glazing 100 includes a surface coating layer provided on at least one of face two or face three of the laminated glazing. The coated laminated glazing 100 further includes an etched area 104,106 selectively provided on the surface coating layer.

Further, the coated laminated glazing comprises a data transponder 102 or antenna positioned below the etched area and sandwiched between a first substrate 100a and a second substrate 100b of the glazing 100. Alternatively, the data transponder 102 is fixed in close proximity to the etched area 108 on exterior faces of the laminated glazing such as face 1 or face 4 using an adhesive or tape. The etched area is characterized by a plurality of disjoint patterns to provide improved data readability through RF transparency. The etching is performed by laser, abrasion, chemical etching and the like. In an embodiment, the second substrate 100b comprises a etched region 108. The etched region 108 includes patterns such as bar code or QR code type that are physically removed from the coated glazing. The patterns provide electrical discontinuity of the surface coating layer and thus prevents electromagnetic interference. Further, the disjoint patterns disable electrical conductivity, to prevent reflection and or infinite conduction of the wirelessly received RF power in the coating region and electromagnetic reflection.

With respect to FIG. 1B, the surface coating layer is provided on face 2 and face 4 of the laminated glazing 101. Further, the coated laminated glazing 100 further includes an etched area 108,110 selectively provided on the surface coating layer. Thus, the surface coating layer 114 can be part of face 1, face 2, face 3 or face 4 or a combination thereof. of the laminated glazing.

In an embodiment, one or both the first substrate 100a and second substrate 100b is a glass or a polymer. The glass can be annealed or tempered. The polymer is polycarbonate (PC) or polypropylene (PP). The first substrate 100a and second substrate 100b can be of various shapes such as flat, curved, wedged or contoured. At least the first substrate 100a, the second substrate 100b is coated with a surface coating layer to provide UV protection and heat protection. The surface coating layer 114 consists of metal layer deposition of tin oxide, indium oxide, chromium, titanium, silver, gold, aluminum, copper or nickel or combination thereof. The first substrate 100a, the second substrate 100b or both the first and the second substrate 100a, 100b may have a thickness of at least 0.5 mm. One or more interlayers 100c provided between the first substrate 100a and second substrate 100b to form the laminated assembly. Thereafter, the RFID device 102 is integrated between the first substrate 100a, second substrate 100b, or one or more interlayers 100c. The RFID device 102 is vertically aligned to the etched region 104. Thus, the etched region provides a gateway for to-and-fro transmission of signal. Further, the etched region 104 allows to store information through the patterns generated.

In an embodiment, the etching is performed to achieve a first pattern in a chip area 102b of the data transponder and a second pattern in an antenna area 102a of the data transponder. The first pattern and the second pattern could be similar or different. The first pattern near the chip area is sparsely etched and the second pattern near the antenna is densely etched. The multiple pattern ensures protection to the chip while providing optimum readability of the antenna. The etching is selectively performed in a range of 10 to 90% removal of the metal based coating to achieve readability in the range of 30 to 98%. In another example, the etching is selectively performed only in area vertically aligned with the antenna area 102a of the data transponder. However, the area vertically aligned to the chip area 102b of the data transponder is not etched.

According to an embodiment of the present invention, the QR or the bar code contains data which can contain Batch number, type of glass, coating details, month of production, Process station ID code, Glass specific details such as if the glass is going to be for acoustic or wedge or standard PVB, quality standard specification number, glass model name, ERP database reference number, customer specific details such as for which market the glass being made M1, M2, M3 etc. The aforementioned data can be made unique for entire batch of the glass being manufactured or even can be kept same for the batch.

In an embodiment, the one or more interlayers 100c comprises a polymer selected from the group consisting of poly vinyl butyral (PVB), polycarbonate (PC), acoustic PVB, shade band PVB, thermal control PVB, ethylene vinyl acetate (EVA), thermoplastic polyurethane (TPU), ionomer, a thermoplastic material, polybutylene terephthalate (PBT), polyethylenevinylacetate (PET), polyethylene naphthalate (PEN), polyvinyl chloride (PVC), polyvinyl fluorides (PVf), polyacrylate (PA), polymethyl methacrylate (PMMA), polyurethane (PUR) and combinations thereof.

The interlayers 100c either has uniform thickness throughout or non-uniform thickness. The interlayer 100c interlayers may have a thickness of at least 0.38 mm. Optionally, the interlayers 100c are modified to accommodate one or more data transponders such as NFC device and RFID tag.

The data transponder device is integrated in the laminated glazing by printing, depositing or patching. The data transponder devices can be directly printed onto the first or second substrate 100a, 100b or the interlayer 100c by means of screen printing or any known printing process with multiple layers onto one another. The data transponder devices can also be deposited over the first or second substrate 100a, 100b directly either by physical vapor deposition coating or chemical vapor deposition coating or any coating techniques. In some instances, the data transponder devices can be a separate thin film patch which can be fixed optionally by adhesive either on first or second substrate 100a, 100b or on the interlayer 100c. Optionally, the data transponder devices are cured during the integration in the laminated glazing 100. The curing of the data transponder devices can be done by infrared or ultraviolet rays.

In an embodiment, the data transponder devices comprise of antenna 102a, and a chip 102b. The antenna 102a and the chip 102b are coupled together. The antenna 102a is designed for receiving and transmitting signals. The chip includes an integrated circuit for processing the information. The chip 102b comprises of a memory. The memory consists of a read-only portion ad re-writable portion. The read-only portion store data which cannot be altered and the re-writable portion store data which can be altered.

FIG. 1C illustrates a cross sectional view of the coated laminated glazing with protective layer 110, according to an embodiment of the present disclosure. In an embodiment, the coated laminated glazing includes the first substrate 100a with an etched region 112 on the surface coating layer 114. Some portion of the etched region 112 is further masked by a protective layer 110. Further, the coated laminated glazing includes one or more interlayers 100c provided between the first substrate 100a and second substrate 100b to form the laminated assembly. Subsequently, the RFID device 102 is disposed on the interlayer 100c such that the RFID device 102 is sandwiched between the first substrate 100a and second substrate 100b. The RFID device 102 is positioned to vertically align with the etched region 112 such that the chip 102b is positioned below the protective layer 110. Thus, the protective layer 110 provides mechanical integrity, ultra-violet insulation, thermal resistance and electrical insulation for the data transponder. The protective layer in the etched area or clear zone ensure that degradation does not occur to the RFID in harsher environments. The protection layer also provides corrosion protection, abrasion protection and UV protection while ensuring RF transparency.

According to an embodiment of the present invention, the protective layer 110 is designed to provide enhancement of mechanical, electrical, and thermal properties while integration. The thickness and type of layers are selected based on application/operation conditions. In an embodiment, the laminated glazing includes one or more protective layers depending on the properties required. If necessary, for some of the sensor based systems, like moisture/humidity, cut-outs can be made in the layers for sensing elements to be exposed for capturing data. Examples of protective layer used for mechanical integrity includes Parylene, silicone, acrylic, epoxy based resin coatings or layers, Ceramic coatings or layers, Ceramic and stainless steel encapsulation. Examples of protective layer used for electrical insulation includes Polymer layers such as polycarbonate (PC), polyvinyl chloride (PVC), polyimide, PVB, poly vinyl butyral (PVB), polycarbonate (PC), Polyurethane (PU), Polytetrafluoroethylene (PTFE) and ceramic coatings. Examples of protective layer used for thermal resistance includes polycarbonate (PC), polyvinyl chloride (PVC), polyimide, poly vinyl butyral (PVB), polycarbonate (PC), Polyurethane (PU), polytetrafluoroethylene (PTFE), polyester, polyurethane, polypropylene, and/or polyimides, polysulfone (PSU), polyethersulfone (PES) and polyetherimide (PEI), polyphenylene sulfide (PPS), polyetheretherketone (PEEK), polyether ketones (PEK), aromatic polymers, poly p-phenylene, ethylene propylene rubber, cross-linked polyethylene, Polytetrafluoroethylene (PTFE) and Teflon. In an exemplary embodiment, the experiment values in which the aging of the protective layer such as polyamide with respect to retention rate of tensile strength from literature clearly shows the performance of the polymers. The rate of retention of tensile strength is in the range of 60% to 100%@4000 hrs Max.

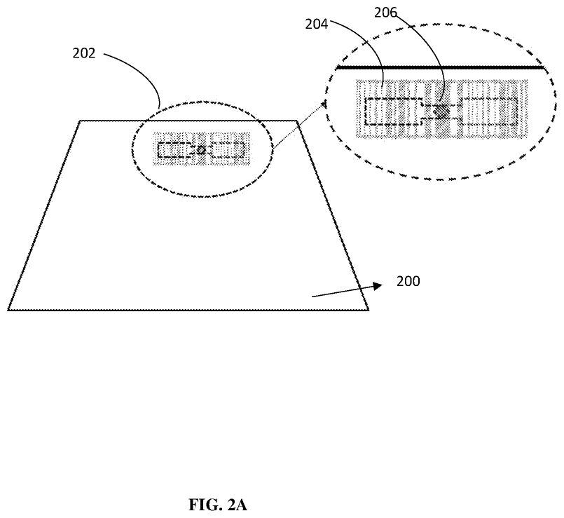

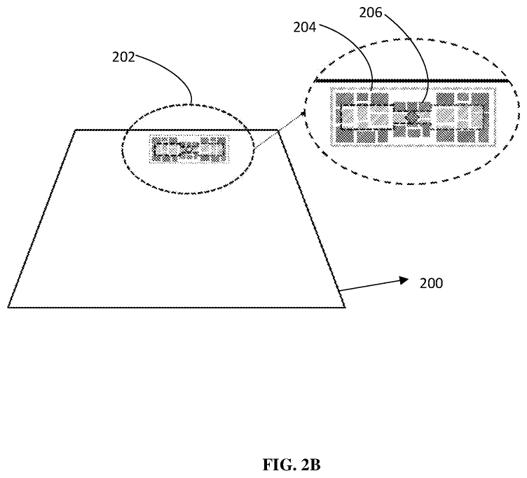

FIGS. 2A and 2B illustrates a perspective view of a windshield 200 with etching pattern, according to an exemplary embodiment of the present invention. In the example, the coated laminated glazing includes etching in a bar code pattern 202. The bar code pattern 202 is dense in the antenna region 204 of the region of the data transponder. The etching is minimal in the chip region 206 of the data transponder.

With respect to FIG. 2B, the etching is performed in a QR based pattern 204. The operating frequency of NFC device 102 and RFID tag 104 ranges in between 3 kilohertz (KHz) to 10 gigahertz (GHz). The data transponder device is either passive or active. The patterns ensure the conductivity is disabled in the zone as the coated layer is removed from the glass surface. The coating or surface coating layer removal is done by various surface etching process which are laser based or chemical based. The antenna is placed ideally behind the etched zone so that the antenna doesn't experience interference/noise created due to the coating layer. Thereby, the etched pattern in the coated glazing ensures that there are no differences obtained in terms of functionality or performances of the data transponders. The patterns provided also ensures storage of information in the bar code or QR code.

According to an embodiment of the present invention, the data transponder devices comprise a material selected from the group consisting of metal, conductive polymers, metal grids, carbon nanotubes (CNT) layer, graphene, transparent conductive oxides or conductive oxides. The metal is selected from the group consisting of copper, aluminum, silver or platinum. The transparent conductive oxides are selected from the group consisting of zinc oxide or indium tin oxide. The conductive polymers are selected from the group consisting of polyaniline or polyindoles.

The data transponder further comprises of a stack of layers consisting of a substrate, an antennae, a chip and an overlay, wherein the substrate and overlay are comprised of a glass or a polymer, wherein the polymer is selected from a group consisting of poly vinyl butyral (PVB), polycarbonate (PC), acoustic PVB, shade band PVB, thermal control PVB, ethylene vinyl acetate (EVA), thermoplastic polyurethane and/or polyvinyl chloride and/or polyester and/or (TPU), ionomer, a thermoplastic material, polybutylene terephthalate (PBT), polyethylenevinylacetate (PET) and/or polycarbonate and/or polypropylene and/or polyethylene and/or polyurethacrylate), polyethylene naphthalate (PEN), polyvinyl chloride (PVC), polyvinyl fluorides (PVf), polyacrylate (PA), polymethyl methacrylate (PMMA), polyurethane (PUR), PDMS and PDMS metal oxide combination or combinations thereof.

FIG. 2C illustrates a coated laminated glazing 200 for a windshield with one or more disjoint patterns 202. The laminated glazing 100 is provided with embedded data transponders such as NFC device and RFID tag or an antenna. The data transponder 104 is placed adjacent or vertically aligned to the etched area 206. In an embodiment, the data transponder 104 is deposited on the interlayer present within the glazing 100. In another embodiment, the data transponder 104 is placed on the face 2 or face 3 of the laminated glazing. In yet another embodiment, the data transponder 104 is fixed on face 1 or face 4 of the laminated glazing.

The disjoint pattern 202 includes a combination of QR pattern 204 and the bar code pattern 206. The densely etched QR patterns 208 is provided near the antenna area of the data transponder. Further, the sparsely etched bar code pattern 206 is positioned adjacent to the chip area of the data transponder. The patterns ensure there is variation in reflectivity in terms of RF signal. The disjoint pattern enables there is no possibilities of electrical conductivity through the metal layer.

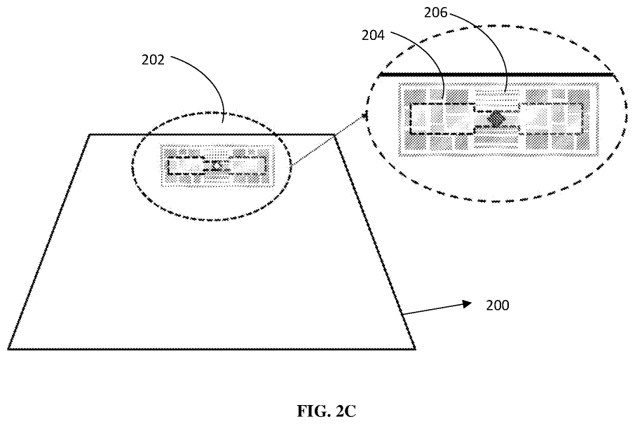

FIGS. 3A, 3B and 3C illustrates various examples of the etching pattern. With respect to FIG. 3A, the etching is performed in the range of 70 percent to form disjoint patterns. With respect to FIG. 3B, the etching is performed in the range of 50 percent to form disjoint patterns. With respect to FIG. 3C, the etching is performed in the range of 30 percent to form disjoint patterns. The percentage of etching required is determined based on the performance of the RFID device required for various applications.

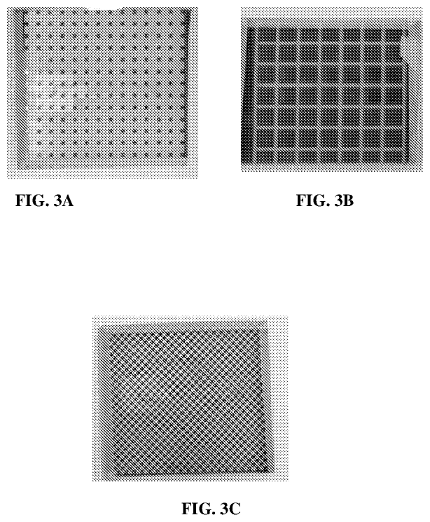

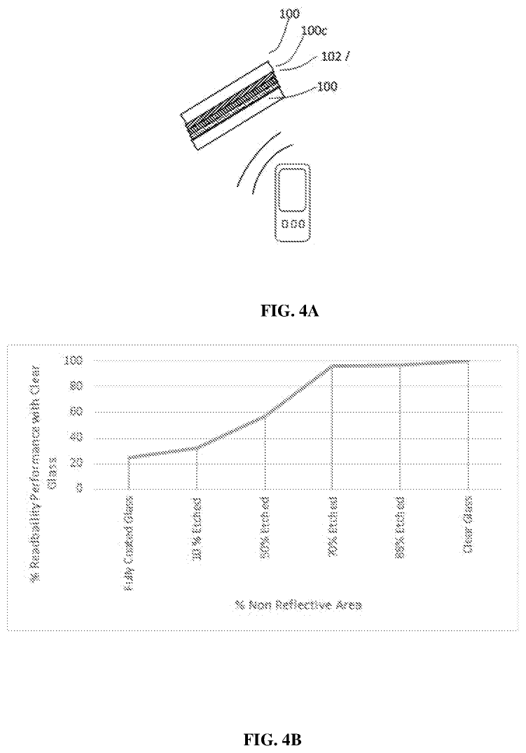

FIG. 4A illustrates an experimental setup to measure performance of the RFID device embedded in the coated laminated glazing. In the experimental setup, the area of etching in the coated glazing was varied in different percentages such as 10%, 30%, 50%, 70%, 88% of the antenna (as shown in FIGS. 3A, 3B, and 3C). These samples are measured in an open environment with a standard hand held RFID reader. The antenna strength was maintained in standard strength of 270 dB and the tag readability was assessed in relevant with the Received Signal Strength Indication (RSSI) number.

FIG. 4B illustrates the readability data obtained with various etching patterns. The etching patterns causes variation in reflectivity in terms of RF signal. The variation is measured in an open environment and also with a varied patterns and the result is provided in the graph 4B. Thus it is observed that there exists difference in the level of performance increment with respect to different iterations. The grid like etched patterns near the antennae is varied and accordingly variation in terms of signal reception is observed. The performance is optimum at an etching of 50-70 percentage. In one embodiment, the etching can be done partially to remove a top layer of conductive material to a predefined thickness. That is the etching will retain a thin layer of surface coating layer rather than completely eliminating the coating layer.

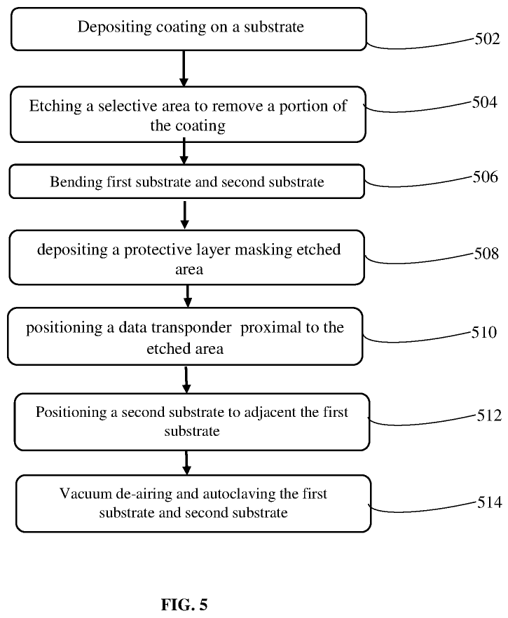

FIG. 5 illustrates a flowchart for a method of manufacturing a coated laminated glazing used in vehicles with data transponders embedded. The method includes depositing a coating uniformly on a substrate of the laminated glazing, the coating being non-transmitting to radio frequency (RF) radiation (502). The coating is formed of a surface coating layer of metal or metal oxides. The coated is provided on inner layer of the first substrate or outer layer of the second substrate. Thereafter, an area of the coated substrate is selectively etched to remove a portion of the coating to form one or more disjoint patterns on the substrate that disable electrical conductivity in the selected area (504). The disjoint patterns can be uniform or non-uniform in the etched area. The disjoint pattern is dense in a first area and minimal in a second area. Subsequently, the coated substrate is bend so that the coated second face forms into a concave shape (506). A protective layer is deposited to mask the etched area (508). Thereafter, the data transponder is positioned at a specified angle to the etched or processed area (510). A second substrate is positioned beneath the substrate having the data transponder sandwiched between the first substrate and the second substrate (512). A vacuum de-airing of the sandwiched first substrate and the second substrate is performed (514). Vacuum De-airing is followed by autoclaving of the sandwiched first substrate and the second substrate.

### Advantages

With respect to the partially etched metal coated glazing, it provides benefits in case of heating the glass where in case of the fully etched window the heating in the local zone is not feasible. In case of partial etch, the heat is transferred though the small etched regions and the metal coatings are also partially heated up. This is very critical in terms of areas where camera is mounted. A fully etched portion near camera zone which is not properly heated may result in challenging situations.

The partially etched coating provides more safety for the data transponder in terms of UV protection, high solar load failure etc. The electrical continuity is disabled by partially etching whereas the thermal benefit is still enabled. The proposed solution is cost-effective with reference to existing cut-outs for metal coatings.

### INDUSTRIAL APPLICATION

The coated laminated glazing of the present disclosure is a laminated glass pane which can be installed in a building or a windshield, windscreen or sunroof or automobile glazing which can be installed in a motor vehicle.

According to the basic construction described above, the automobile glazing system of the present invention may be subject to changes in materials, dimensions, constructive details and/or functional and/or ornamental configuration without departing from the scope of the protection claimed.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

The description in combination with the figures is provided to assist in understanding the teachings disclosed herein, is provided to assist in describing the teachings, and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

### LIST OF ELEMENTS

100 laminated glazing
100a first substrate
100b second substrate
100c interlayer
102 RFID tag
102a RFID antenna
102b RFID chip
112 UV protection layer
116 surface coating layer
104, 106, 108, 110 etched areas

1. A coated laminated glazing comprising:
a first substrate, a second substrate, and one or more interlayers,
a surface coating layer provided on at least the first substrate or the second substrate and one or more etched areas selectively provided on the surface coating layer; and
a data transponder or an antenna sandwiched between the first substrate and the second substrate proximal to the one or more etched areas or attached externally to the first substrate and the second substrate proximal to the one or more etched areas, wherein the one or more etched areas include one or more disjoint patterns to provide improved readability of the data transponder or the antenna.

2. The coated laminated glazing as claimed in claim 1, wherein the one or more etched areas are selectively provided on the surface coating layer by laser etching, abrasion or chemical etching.

3. (canceled)

4. The coated laminated glazing as claimed in claim 1, wherein the one or more disjoint patterns are provided to disable electrical conductivity and infinite conduction of the wirelessly received RF power in the coating region.

5. The coated laminated glazing as in claim 1, wherein the surface coating layer is present on an outer layer of the first substrate, an inner layer of the first substrate, an outer layer of the second substrate, and an inner layer of the second substrate; and
said coated laminated glazing is configured to communicate with a reader to transmit and receive signal therefrom.

6. The coated laminated glazing as claimed in claim 1, wherein the one or more disjointed patterns minimize electromagnetic reflection.

7. The coated laminated glazing claimed in claim 1, wherein the surface coating layer is composed of at least one of metal or metal oxides, consisting of aluminum, silver, copper, Nickel, zinc, platinum, chromium, titanium, and Inconel, Aluminum oxide, Indium oxide, Chromium oxide, Titanium Oxide, Titanium Zirconium oxide, zinc oxide.

8. The coated laminated glazing as claimed in claim 1, optionally comprising a protective layer selectively disposed between the first substrate and the second substrate to provide mechanical integrity, ultra-violet protection, thermal resistance and electrical insulation for the data transponder.

9. The coated laminated glazing as claimed in claim 8, wherein the protective layer is composed of at least one of or a combination of parylene, silicone, acrylic, epoxy based resin, ceramics, polycarbonate (PC), polyvinyl chloride (PVC), polyimide, PVB, poly vinyl butyral (PVB), polycarbonate (PC), Polyurethane (PU), polytetrafluoroethylene (PTFE), polyester, polyurethane, polypropylene, and/or polyimides, polysulfone (PSU), polyethersulfone (PES) and polyetherimide (PEI), polyphenylene sulfide (PPS), polyetheretherketone (PEEK), polyether ketones (PEK), aromatic polymers, poly p-phenylene, ethylene propylene rubber, crosslinked polyethylene, Polytetrafluoroethylene (PTFE), PDMS and PDMS metal oxide combination and Teflon.

10. The coated laminated glazing as claimed in claim 1, wherein etching of the surface coating layer is performed to achieve a first pattern in an area proximal to chip of the data transponder and a second pattern in an area proximal to the antenna of the data transponder, wherein the first pattern and the second pattern is non-uniform and dis-similar.

11. The coated laminated glazing as claimed in claim 1, wherein etching of the surface coating layer is selectively performed in a range of 10 to 90% of the said conductive surface layer to achieve readability in the range of 30 to 98%.

12. The coated laminated glazing as claimed in claim 1, wherein etching of the surface coating layer is selectively performed to enable RF transparency in the antenna area of the data transponder while surface coating layer is retained in a chip area of the data transponder for enabling UV protection.

13. The coated glazing as claimed in claim 1, wherein the one or more disjoint patterns comprises one of bar code, QR code or any grid pattern or a combination thereof.

14. (canceled)

15. The coated laminated glazing as claimed in claim 1 is configured for attaching on to a vehicle, wherein said coated laminated glazing is used in a windshield, windscreen and/or sunroof of the vehicle.

16. (canceled)

17. A method of manufacturing a coated laminated glazing with improved readability, the method comprising:
depositing a coating uniformly on a first or a second substrate, the coating being at least partially non-transmitting to radio frequency (RF) radiation, wherein the second substrate is deposited with a metal coating;
selectively etching an area of the substrate to remove a portion of the coating to form one or more disjoint patterns on the substrate;
bending the first substrate and second substrate to form a concave shape;
depositing a protective layer on at least one of the first substrate or the second substrate;
positioning a data transponder at a specified angle to the etched or processed area;
positioning a second substrate beneath the first substrate such that the data transponder is sandwiched between the first substrate and the second substrate;
positioning one or more interlayers between first and second substrate to form a sandwiched laminate assembly;
vacuum de-airing of the sandwiched laminate assembly; and
autoclaving the sandwiched laminate assembly.

18. The method as claimed in claim 17, wherein the one or more disjoint patterns are etched to minimize reflection of the radio signal from the reader.

19. (canceled)

20. The method as in claim 17, wherein selectively etching is performed on the surface coating layer deposited on first or second substrate.

21. The method as claimed in claim 17, wherein forming one or more disjoint patterns further comprises encoding QR code and or bar code information onto the one or more pattern.

22. The method as claimed in claim 17, wherein the one or more disjoint patterns are formed on the substrate such that more than ten percent of the coating is removed by etching.

23. The method as claimed as in claim 17, wherein the selectively etching comprises:
etching a first pattern on an area proximal to a chip of the data transponder; and
etching a second pattern on an area proximal to the antenna area of the data transponder.

24. The method as claimed in claim 23, wherein the first pattern is densely etched and the second pattern is sparsely etched.
